(19) United States
(12) Patent Application Publication
(10) Pub. No.: US 2017/0037784 A1
(43) Pub. Date: Feb. 9, 2017

(54) DEVICE AND METHOD FOR STARTING AN AUXILIARY POWER UNIT

(71) Applicant: SAFRAN POWER UNITS, Toulouse (FR)

(72) Inventors: Stephane CHEVALIER, Colomiers (FR); Remi JOACHIM, Dremil-lafage (FR); Remy PEDOUX, Cepet (FR)

(73) Assignee: SAFRAN POWER UNITS, Toulouse (FR)

(21) Appl. No.: 15/305,079

(22) PCT Filed: Apr. 22, 2015
(86) PCT No.: PCT/FR2015/051098

§ 371 Date: Oct. 18, 2016

(30) Foreign Application Priority Data
Apr. 24, 2014 (FR) 1453713

(51) Int. Cl. F02C 7/275; F02N 11/08

(52) U.S. Cl. CPC F02C 7/275; F02N 11/08; F02N 2200/022; F02N 2200/063; F02N 2300/102; F05D 2220/50; F05D 2260/85

(57) ABSTRACT

The invention relates to a starting device for an auxiliary power unit (10), comprising a control unit (32) of the power supply of a starter motor (12), said motor (12) being suitable to be supplied with power by a supply network (16) and configured to drive a revolution of the auxiliary power unit (10), the control unit (32) being suitable to receive an item of information representative of the speed of rotation of the auxiliary power unit (10) and control of the power supply of the starter motor (12) by the control unit (32) being dependent on said item of information representative of the speed of rotation.

The device is characterised in that the control unit (32) is suitable to receive an item of information representative of the voltage of the power supply network (16) and in that control of the power supply of the starter motor (12) by the control unit (32) is dependent on said item of information representative of the voltage.

### 1. TECHNICAL FIELD OF THE INVENTION

The invention relates to a starting device for an auxiliary power unit.

### 2. PRIOR ART

An auxiliary power unit, abbreviated to APU, can supply power to aircraft devices (alternators, pumps, load compressors, air conditioning units, etc.) directly and/or indirectly via a multiple outlet power transfer unit, abbreviated to PTU, in particular during transient flight conditions (take-off, acceleration, stationary flight for helicopters, etc.). During stable conditions, such as cruising, for example, the APU can generate the electricity required, via a generator, for the devices in addition to, or instead of, the main engines.

On aircraft, the power required to start the APU is supplied either by batteries or by an external auxiliary unit (a ground truck or airport supply network), or alternatively by the electrical generation of the main engines. The APU is started by a series-type direct current electric motor known as a starter motor. This inevitably leads to the presence of very variable available voltage and power to produce the same type of starting of the APU.

The APU starter motor is directly connected to the on-board network (or supply network) of the aircraft through a power contactor. Depending on the type and state of charge of the continuous electric generators supplying the on-board network, APU starts result that vary in difficulty or are even aborted in extreme conditions of the on-board network. These starting problems result in particular from excessive acceleration which does not leave enough time to light the fuel/oxidiser mixture in the APU.

To limit the influence of said on-board network fluctuations, one solution is to connect in series a resistance known as a starting resistance with the starter motor, allowing a fall in voltage and limiting the current consumed by the motor, and thus limiting the rotational acceleration of the APU.

However, this solution does not completely eliminate the influence of the on-board fluctuations, as said fluctuations can cause variations in acceleration by a factor of up to twenty during the starting phases, making the ignition and starting of the APU difficult to control.

Furthermore, if the network voltage is high, the starter motor consumes a large portion of the excess voltage through the starting resistance, which causes significant losses by the Joule effect. The power consumption of the starter motor is therefore not optimised.

Another solution that has been proposed is to use a brushless motor with permanent magnets or with variable-torque reluctance controlled with a current inverter. However, this solution is complex and costly compared with a series-type direct current motor.

### 3. OBJECTIVES OF THE INVENTION

The invention aims to overcome at least some of the drawbacks of known auxiliary power unit starting devices.

In particular, the invention also aims to provide, in at least one embodiment of the invention, a starting device which makes it possible to avoid being subject to the power and voltage variations of the on-board network of the aircraft.

The invention also aims to provide, in at least one embodiment, a starting device that permits more robust starting of the APU.

The invention also aims to provide, in at least one embodiment, a starting device that reduces energy losses.

The invention also aims to provide, in at least one embodiment, a starting device with a lower mass.

The invention also aims to provide, in at least one embodiment, a starting device with a lower cost.

### 4. DISCLOSURE OF THE INVENTION

Accordingly, the invention relates to a starting device for an auxiliary power unit, comprising a control unit of the power supply of a starter motor, said motor being suitable to be supplied with power by a supply network and configured to drive a revolution of the auxiliary power unit, the control unit being suitable to receive an item of information representative of the speed of rotation of the auxiliary power unit, control of the power supply of the starter motor by the control unit being dependent on said item of information representative of the speed of rotation, characterised in that the control unit is suitable to receive an item of information representative of the voltage of the power supply network and in that control of the power supply of the starter motor by the control unit is dependent on said item of information representative of the voltage.

A device according to the invention therefore allows starting of the auxiliary power unit that takes account of the speed of rotation of said unit by control of the power supply of the starter motor. Said taking account in the control of the power supply allows excessive fluctuations in acceleration to be reduced and thus, owing to the controlled speed, allows more robust starting, particularly during ignition of the engine, for which the speed of rotation conditions for a metered amount of fuel and oxidiser conducive to ignition of the auxiliary power unit are within a reduced speed range depending on the type and/or size of the auxiliary power unit. In other words, a device according to the invention thus allows, for example, controlled acceleration of the rotation of the auxiliary power unit at ignition and therefore a longer time interval during which the speed of rotation of the auxiliary power unit falls within said reduced speed range for optimal ignition.

Moreover, the control unit adjusts control to take account of fluctuations in the voltage of the power supply network. This allows the starter motor to be supplied only with the energy required for operation thereof while minimising losses. This also allows starting to be controlled whatever electricity generator/s supply electric power to the supply network (battery, ground truck, airport supply network, main engines, etc.).

Advantageously and according to the invention, said information representative of the speed of rotation of the auxiliary power unit is the speed of rotation of the auxiliary power unit. Preferably, the device according to the invention comprises a sensor configured to measure said speed of rotation of the auxiliary power unit.

Advantageously and according to the invention, said information representative of the voltage of the power supply network is the voltage of the power supply network.

Advantageously and according to the invention, control of the power supply of the starter motor by the control unit is produced by a pulse width modulation signal.

According to this aspect of the invention, the pulse width modulation signal allows control of the power supply of the starter motor to be simplified. Moreover, this allows, for example, the use of a series direct current motor as a starter motor, which motor is simple to use and inexpensive.

Advantageously and according to the invention, control of the power supply of the starter motor by the control unit is produced by a pulse width modulation signal, the pulse width modulations of said signal being dependent on the speed of rotation of the auxiliary power unit and of the voltage of the power supply network.

According to this aspect of the invention, the pulse width modulation signal allows the starter motor to be controlled by a signal of which the pulse widths depend on both the voltage of the power supply network, in order to reduce the influence of the fluctuations of said voltage on the motor, and also the speed of the auxiliary power unit, in order to control said speed, in particular by maintaining an optimum speed at the moment of ignition of the auxiliary power unit and controlling the acceleration thereof.

Advantageously and according to this last aspect of the invention, the device comprises a commutator configured to allow the connection or disconnection of the starter motor to or from the power supply network, and control of the power supply of the starter motor is transmitted to the commutator by the control unit.

According to this aspect of the invention, control of the power supply in pulse width modulation is by an all or nothing signal allowing a commutator to be closed and opened and thus to regulate the power supply of the starter motor by connection and disconnection thereof respectively to or from the power supply network, depending on the modulation of the control.

The use of said commutator instead and in place of the contactors and starting resistance of the prior art also allows the mass of the components required to start the auxiliary power unit to be reduced, and also the cost of forming the device. Furthermore, the only energy losses are those linked to the commutation of the commutator, which are far less than the losses of a device of the prior art.

The invention also relates to a method of starting an auxiliary power unit, comprising a step of controlling the power supply of a starter motor by a power supply network, said motor being configured to drive a revolution of the auxiliary power unit, the starting method comprising a step of receiving an item of information representative of the speed of rotation of the auxiliary power unit and the step of controlling the power supply being dependent on said item of information representative of the speed of rotation, characterised in that it comprises a step of receiving an item of information representative of the voltage of the power supply network and in that the step of controlling the power supply is dependent on said item of information representative of the voltage.

Advantageously and according to the invention, the starting method comprises a step of measuring said speed of rotation of the auxiliary power unit.

Advantageously and according to the invention, the step of controlling the power supply is produced by automatic control of the average voltage applied to the terminals of the starter motor by said item of information representative of the speed of rotation of the auxiliary power unit.

Advantageously and according to the invention, the starting method comprises an ignition step during which the speed of rotation of the auxiliary power unit is stabilised at a speed that falls within an ignition interval of the power unit.

Ignition interval means a speed range in which the speed of rotation of the auxiliary power unit must be situated in order that the fuel/oxidiser mixture inside said power unit allows ignition of said unit by lighting said mixture.

Said stabilisation of the speed helps ensure more robust ignition of the auxiliary power unit, by controlling the adjustment of the metered amounts of the fuel/oxidiser mixture owing to a speed of rotation that falls within an optimal ignition range.

Advantageously, the device according to the invention implements the starting method according to the invention.

Advantageously, the starting method according to the invention is implemented by the device according to the invention.

The invention also relates to a method for regulating the speed of rotation of an auxiliary power unit suitable to be driven in rotation by a starter motor and/or by the combustion of a metered amount of fuel/oxidiser internal to said unit, said method being a regulation method characterised in that it comprises:
a starting step following the starting method according to the invention,
a transition step in which the auxiliary power unit is driven in rotation jointly by said starter motor and by said combustion of the metered amount of fuel/oxidiser,
a cruising step during which the auxiliary power unit is driven in rotation solely by combustion of the metered amount of fuel/oxidiser.

Advantageously and according to the invention, the regulation method comprises a step of stopping the starter motor.

The invention also relates to a device or a method characterised in combination by all or some of the features mentioned above or below.

### 5. LIST OF FIGURES

Other objects, features and advantages will appear on reading the following description which is given solely by way of non-limiting illustration, and refers to the accompanying drawings in which:

FIG. 1 shows diagrammatically a starting device of the prior art,

FIG. 2 shows diagrammatically a starting device according to an embodiment of the invention,

FIG. 3 shows different curves for the speed of rotation of the auxiliary power unit, expressed in revolutions per minute, as a function of the time, expressed in seconds, according to the prior art and according to different embodiments of the invention.

### 6. DETAILED DESCRIPTION OF AN EMBODIMENT OF THE INVENTION

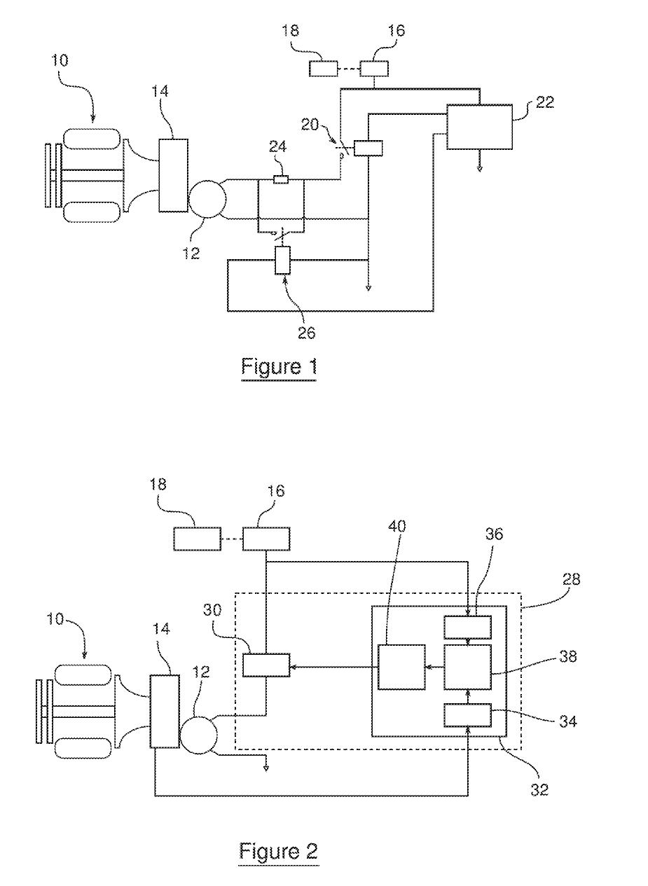

FIG. 1 shows a starting device as currently used in the prior art, in other words representing the art prior to the invention.

An auxiliary power unit 10, abbreviated to APU, is installed in an aircraft, for example. The APU 10 is associated with a starter motor 12 by means of a relay box 14 comprising a gear train that provides a reduction such that the starter motor 12 drives the rotation of the APU 10. The starter motor 12 is usually a direct current series-type electric motor, supplied electrically via a power supply network 16 of the aircraft, also known as the on-board network, which supplies the necessary electrical power for the operation thereof. Depending on the situation, the power supply network 16 comprises one or more supply generators 18 which supply said electrical power, such as batteries, an external auxiliary unit (ground truck or airport supply network) or the main engines of the aircraft, for example. The connection between the power supply network 16 and the starter motor 12 is made via a launch contactor 20 controlled in all or nothing mode by a launch control unit 22. A starting resistance 24 is mounted in series with the starter motor 12 and can be short-circuited by means of a starting contactor 26, also controlled in all or nothing mode by the launch control unit 22.

During the launch of the APU 10, the launch control unit 22 controls the closing of the launch contactor 20, which has the effect of connecting the starter motor 12 to the power supply network 16. The starting resistance 24 in series with the starter motor 12 allows the current consumed to be limited and causes the voltage at the terminals of the starter motor 12 to fall. Once the APU 10 has made the initial rotations, the starting resistance 24 is short-circuited via the starting contactor 26 so that the APU 10 is directly connected to the power supply network 16.

The starter motor 12 therefore absorbs all the power that the power supply network 16 can supply thereto, in particular via the starting resistance 24. This may cause significant variations in acceleration when the power supply network 16 experiences large current or voltage fluctuations. Moreover, the large amount of power through the starting resistance 24 causes losses by the Joule effect.

FIG. 2 shows diagrammatically a starting device 28 according to an embodiment of the invention. The starting device 28 comprises a commutator 30 and a control unit 32. The starter motor 12 is in this case connected to the power supply network 16 via the commutator 30, said commutator being of the electronic power type, in other words suitable for causing a large amount of current to circulate, and controlled electronically. The commutator 30 is controlled by means of an instruction transmitted by the control unit 32 in the form of an electronic signal.

The control unit 32 furthermore receives different items of information representative of the operation of the APU 10 and of the power supply network 16, taken by measuring means, which are external or internal to the control unit 32, notably sensors. In particular, the control unit 32 acquires the speed of rotation of the APU 10, via a module 34 for acquiring the speed of the APU 10, and acquires the voltage of the power supply network 16, via a module 36 for acquiring the voltage of the power supply network 16.

Said two items of information are transmitted in the control unit 32 to a processing module 38, responsible for controlling the rotation of the APU 10 in the ignition and starting phase. Said processing module 38 will define the instruction to be transmitted to the commutator 30 by means of the control module 40 in order to allow optimal ignition and starting of the APU 10. The instruction in this case is a pulse width modulation (or PWM) instruction. Like any PWM signal, the control has the characteristic of having a high level, a low level, a period and a duty cycle defined by the time during which the control is at the high level, divided by the period. For the commutator 30, the high level of said control corresponds to a closing of the commutator 30 (and thus supply of the starter motor 12 by the power supply network 16), and the low level of said control corresponds to an opening of the commutator 30 (and thus cutting off the power supply of the starter motor 12 by the power supply network 16).

Said modulation allows control of the connection between the starter motor 12 and the power supply network 16, in other words control of the rotation of the APU 10 via the power supply of the starter motor 12.

Modulation of the instruction is produced in particular depending on the voltage of the power supply network 16, transmitted by the module 36 for acquiring the voltage of the power supply network 16. Modulation is produced by variation of the duty cycle of the control, such that the average voltage at the terminals of the starter motor 12 is close to a defined desired voltage to be applied, regardless of the voltage of the power supply network 16: for example, the starter motor 12 is to be supplied with a desired voltage of approximately 16V. If the module 36 for acquiring the voltage transmits a voltage measurement of the power supply network 16 that is equal to 32V, the control is modulated so that the duty cycle is 50%, that is, an average voltage value at the terminals of the starter motor 12 of 50% of 32V, which is 16V. If, because of fluctuations of the voltage of the power supply network 16, said voltage is equal to 20V, the instruction is modulated so that the duty cycle is 80%, that is, an average voltage value at the terminals of the starter motor 12 of 80% of 20V, which is 16V.

Modulation of the instruction is also produced in particular depending on the speed of rotation of the APU 10, and depending on the variation of said speed as a function of the time, in other words the acceleration of the APU 10. The speed of rotation of the APU is dependent on the starter motor 12, the speed and acceleration of which depend in particular on the voltage at the terminals thereof. Thus, modulation of the instruction is produced depending on the desired average voltage to be applied at the terminals of the starter motor 12. The variation of the duty cycle allows a variation of said average voltage at the terminals of the starter motor 12 so as to control the speed and acceleration of the APU 10.

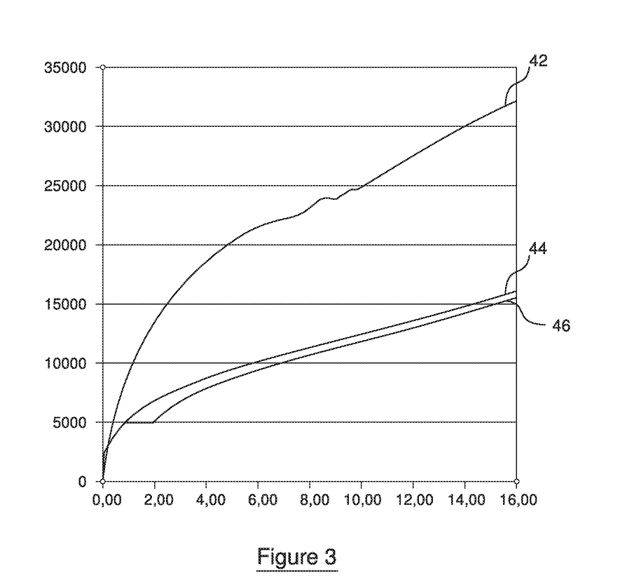

FIG. 3 shows different curves for the speed of rotation of the APU, according to the prior art and according to different embodiments of the invention. In these examples, the voltage of the power supply network has a value of 32V.

The first curve 42 shows the speed of rotation of the APU 10 when it has been launched and started by a starting device according to the prior art. With said device, the starter motor 12 receives all the power that is delivered thereto by the power supply network 16, with no control, which leads to rapid acceleration, in this example of approximately 8400 revolutions per minute per second, and therefore a high speed from the first seconds. For an APU for which the most suitable ignition speed is between 4000 and 6000 revolutions per minute, the available time interval during which the speed of the APU 10 is between said two speeds is approximately 200 ms, which can lead to aborted starts if it has not been possible to light the fuel/oxidiser mixture during said short lapse of time.

The second curve 44 shows the speed of rotation of the APU 10 after it has been launched and started by a starting device 28 according to a first embodiment of the invention. With this type of device, the control unit 32 regulates the power supply of the starter motor 12 depending on the voltage of the power supply network 16 and/or the speed of rotation of the APU 10. Thus, the acceleration of the APU 10 and the speed thereof are controlled: in particular, the acceleration in this example is approximately 2000 revolutions per minute per second. For an APU for which the most suitable ignition speed is between 4000 and 6000 revolutions per minute, the available time interval during which the speed of the APU 10 is between said two speeds is approximately a second, which allows the risk of aborted starts with the starting devices of the prior art to be reduced significantly by improving the chances of successful lighting of the fuel/oxidiser mixture.

The third curve 46 shows the speed of rotation of the APU 10 when it has been launched and started by a starting device 28 according to a second embodiment of the invention. This type of starting device 28 allows similar regulation to the device of the first embodiment described in the previous paragraph, but to which regulation of the speed in a stabilisation zone close to the suitable ignition speed is added. For an APU for which the most suitable ignition speed is between 4000 and 6000 revolutions per minute, the speed of the APU is stabilised for example at 5000 revolutions per minute during the time needed for the APU 10 to achieve ignition, for example in this case about one second. Once the APU 10 has achieved ignition, regulation of the acceleration and speed is produced in a way that is comparable to the first embodiment.

1. A starting device for an auxiliary power unit, comprising a control unit of the power supply of a starter motor, said motor being suitable to be supplied with power by a supply network and configured to drive a revolution of the auxiliary power unit, the control unit being suitable to receive an item of information representative of the speed of rotation of the auxiliary power unit, control of the power supply of the starter motor by the control unit being dependent on said item of information representative of the speed of rotation, wherein the control unit is suitable to receive an item of information representative of the voltage of the power supply network and in that control of the power supply of the starter motor by the control unit is dependent on said item of information representative of the voltage.

2. The starting device according to claim 1, wherein said item of information representative of the speed of rotation of the auxiliary power unit is the speed of rotation of the auxiliary power unit.

3. The starting device according to claim 1, herein said item of information representative of the voltage of the power supply network is the voltage of the power supply network.

4. The starting device according to claim 1, wherein control of the power supply of the starter motor by the control unit is produced by a pulse width modulation signal.

5. The starting device according to claim 1, wherein it comprises a commutator configured to allow the connection or disconnection of the starter motor to or from the power supply network, and in that control of the power supply of the starter motor is transmitted to the commutator by the control unit.

6. A method of starting an auxiliary power unit, comprising a step of controlling the power supply of a starter motor by a power supply network, said motor being configured to drive a revolution of the auxiliary power unit, the starting method comprising a step of receiving an item of information representative of the speed of rotation of the auxiliary power unit and the step of controlling the power supply being dependent on said item of information representative of the speed of rotation, wherein it comprises a step of receiving an item of information representative of the voltage of the power supply network and in that the step of controlling the power supply is dependent on said item of information representative of the voltage.

7. The method of starting according to claim 6, wherein it comprises an ignition step during which the speed of rotation of the auxiliary power unit is stabilised at a speed that falls within an ignition interval of the power unit.

8. The method of regulating the speed of rotation of an auxiliary power unit suitable to be driven in rotation by a starter motor and/or by the combustion of a metered amount of fuel/oxidiser internal to said auxiliary power unit, said method being a regulation method wherein it comprises:
a starting step following the starting method according to claim 6,
a transition step in which the auxiliary power unit is driven in rotation jointly by said starter motor and by said combustion of the metered amount of fuel/oxidiser,
a cruising step during which the auxiliary power unit is driven in rotation solely by combustion of the metered amount of fuel/oxidiser.
